(19) United States
(12) Patent Application Publication
(10) Pub. No.: US 2011/0291611 A1
(43) Pub. Date: Dec. 1, 2011

(54) INTELLIGENT BATTERY POWERED CHARGING SYSTEM

(75) Inventor: Dror Manor, Hertzlia (IL)

(73) Assignee: TECHTIUM LTD., Tel Aviv (IL)

(21) Appl. No.: 13/145,895

(22) PCT Filed: Jan. 24, 2010
(86) PCT No.: PCT/IL2010/000056

§ 371 Date: Aug. 2, 2011

Related U.S. Application Data
(60) Provisional application No. 61/146,360, filed on Jan. 22, 2009.

(51) Int. Cl. H02J 7/00

(52) U.S. Cl. 320/107

(57) ABSTRACT

A charger for providing power to an electronic device from an AC source, incorporating a battery to provide back-up power when no AC source is available. The charger uses a first voltage converter with a smoothing characteristic such that there are periods during each AC cycle, during which the first DC voltage falls substantially from its maximum value, and a second voltage converter, outputting power at a second DC voltage to the electronic device. A battery comprising at least one cell is connected at the output of the first converter such that current can be received by the battery from the first converter and supplied by the battery to the second converter. A controller is used, configured to charge the battery from the first converter, or to supply current from the battery to the second converter for output to the device, during different parts of the AC cycle.

### FIELD OF THE INVENTION

The present invention relates to the field of AC powered power supplies for use with portable electronic devices, especially those incorporating one or more cells having controlled charge and discharge characteristics.

### BACKGROUND OF THE INVENTION

There exist AC wall chargers for supplying current to portable electronic devices, which also incorporate built in batteries in order to continue supplying or charging the portable electronic device even when no wall power is available. Furthermore such wall chargers incorporating batteries can be designed so that if the batteries are rechargeable, connection to the wall socket will enable the batteries to be recharged such that they are always ready to provide power to the portable electronic device. Such wall chargers have been described in the PCT application published as international publication number WO 2008/075358 for “Battery Powered Charger”, having a common inventor with the present application.

Such prior art wall chargers have been described using conventional AC/DC power supply units, which may be bulky and energy inefficient. Furthermore, such prior art wall chargers have generally been described using only a single incorporated battery, which, in terms of its charging and discharging characteristics is regarded as a single voltage source, regardless of its cell content. Additionally, such prior art wall chargers often do not demonstrate any method of control of the charging current into the built-in battery or batteries.

There therefore exists a need for a wall charger which overcomes at least some of the disadvantages of prior art systems and methods.

The disclosures of each of the publications mentioned in this section and in other sections of the specification, are hereby incorporated by reference, each in its entirety.

### SUMMARY OF THE INVENTION

The present disclosure describes new systems for providing power from an AC power source such as a wall socket to an electronic device such as a laptop or a telephone. The power supply system has the ability to continue providing power when no external source is available, by virtue of one or more batteries, preferably rechargeable, either built into the system, or contained in a battery cavity or holder for replacement when necessary. These provide power when the source is unplugged from the AC source. The power provided to the electronic device can be used either to operate the device or to charge its internal batteries or both. The system differs from prior art systems in that it uses a circuit topography including two separate power converters, which enables high efficiency and flexibility in the operation of the system. The topography is similar to that described in co-pending PCT International Application, published as WO2009/113062 for “Environmentally Friendly Power Supply”, having a common inventor with the present application, and herewith incorporated by reference in its entirety. The topography includes an input AC/DC converter, with the internal battery or batteries connected at its output and a controller which manages the current flow to and from the batteries. The output of this AC/DC converter may be used both for charging the internal battery or batteries of this charger, and for passing on to a DC/DC converter for output to the portable device at the voltage level required by the device.

The main smoothing function of the AC/DC converter may advantageously be fulfilled by means of a comparatively small capacitor at its output, such that the output current drops significantly during each half cycle of the AC power, during those periods of time when the AC/DC converter output voltage would fall below that of the battery voltage, so that rectified DC output current does not flow into the battery during these periods. (Throughout this application, the assumption is made that full cycle rectification is used in the AC/DC module, such that cyclic phenomena described occur twice during each cycle of AC, though it is to be understood that the invention is not intended to be limited to this mode.)

However, during the periods of the AC/DC output “dips”, when the AC/DC module cannot supply the load through the DC/DC converter, the current to the load can be supplied from the charge in the battery. This is one major aspect in which the chargers described in this disclosure are different from prior art chargers having an internal battery. Like such prior art chargers, in the present charger, the power for the load is drawn either from the wall power through the AC/DC converter, or from the battery. However, unlike prior art chargers, in the present chargers the source of the output power can alternate dynamically and sequentially during each half cycle, according to the output of the AC/DC converter at each point of the half cycle. During each half cycle, when the AC/DC output voltage is sufficiently high, it becomes the source of the output to the DC/DC converter, and the load. On the other hand, when the AC/DC output voltage falls, and can not generate output current to the DC/DC converter and the load, the internal battery may take over as the source of output power. During the former period, the AC/DC output can also be used to charge the battery, to keep it in a topped up condition. The battery thus acts like a quasi-capacitor in this charging system, supporting the capacitor at the output of the AC/DC converter, in that it is charged by the AC/DC converter when the AC/DC output voltage is high enough, and it supplies the load current to the output device when the AC/DC output voltage is not high enough to do so, with this alternation of function occurring twice during every cycle of the AC power. This analogy of the battery as a quasi-capacitor can be taken a further step, by not providing any significant smoothing to the AC/DC converter. In this extreme case, only the rechargeable battery is used to provide the DC/DC converter and hence the output load with its current during the dips of the AC/DC converter, which in such a case will be longer in duration than when a capacitor is used.

However, even beyond this cyclic division of function, a further aspect of the chargers of the present disclosure is that, since the AC/DC converter output can be used both to charge the internal battery and to drive the output device, a control system can be incorporated in order to determine, according to the needs of the battery, what part of the AC/DC converter output is used to charge the battery, and what part is used for the output load current. The control system is configured to determine the state of the battery, such as whether it is in good condition and fully charged, or whether it is in good condition but depleted and therefore needing significant charging, whether the battery is a secondary cell which can be charged, or whether it is a primary cell, in which case charging current is completely disenabled, and so on. If charging is indicated, the control system can program the AC/DC output to provide charging current according to a charging algorithm providing optimal charging for the charge level and the condition of the battery.

One of the main vehicles by which the system fulfills these functions is by control of the output voltage allowed to build up on the capacitor at the output of the AC/DC converter, as a function of the battery status. The voltage on the output capacitor has a substantial effect on the level of energy stored in the capacitor, since the energy stored is proportional to the square of the voltage on the capacitor. Thus, the controller can use the AC/DC output voltage level to determine whether it is the capacitor charge or the battery charge which supplies the output load with its required current during the AC/DC output dips every half cycle, and this decision can be determined by the controller, inter alia, according to the status of the battery. Thus, when the battery is in a low state of charge, or if no battery is installed at all, the controller is configured to detect this condition, and to raise the AC/DC output voltage, such that the capacitor stores a substantially larger charge, and can thus supply the load without reliance on assistance from the battery. On the other hand, if the battery is in good condition and well charged, the capacitor will be charged to essentially the same voltage as the battery, such that the battery will supply a significant part of the load current during the AC/DC converter dips, and conversely, will be topped up by the AC/DC converter during the plateau output level of the AC/DC converter. The battery thus undergoes alternating charge and discharge periods during each half cycle of the AC power, with the net charge level being thereby maintained.

The power supply topology described above has the smoothing for the AC/DC converter being performed by a comparatively smaller capacitor than is usually used in such rectifier power supplies, with the result that the output voltage is allowed to drop to low levels during the zero level crossing of the AC input. There are significant space, cost and reliability advantages in providing this smoothing by means of a capacitor at the comparatively low voltage output of the AC/DC converter, as fully described in WO2009/113062. However, it is to be understood that those of the exemplary power supply circuits and methods of the present application which are not dependent on the voltage level to which the capacitor is charged, are operable even if the reduced value smoothing capacitor is situated at the conventional location, at the output to the rectifier bridge at the input side of the AC/DC converter, and the invention is not meant to exclude such a configuration, even if commercially less advantageous.

The level of current provided for charging the internal battery or batteries is determined either by the current/voltage characteristics of the AC/DC converter, or by a current controller in series with the battery, such as a gated switch, such as a MOSFET. The internal battery of the charger can be made up either of a single cell, or of multiple cells connected in parallel, with MOSFETs controlling the current flow through each one of them independently. This has the advantage that each cell can be charged according to its state of fill, or of its condition, such that optimum use is made of the available charging current. Additionally, battery chemistry detection circuitry can enable use of mixed cell configurations, with the primary cells being prevented from being charged.

Proper operation of the power supply is ensured by means of a controller, typically a microprocessor or microcontroller which manages the current flow within the power supply. The microprocessor ensures that the DC/DC converter receives the energy needed to power the device, whether from the internal battery module or from the AC/DC converter, and that the AC/DC converter provides charging power to the battery only when battery charging is allowed and requested. The battery module may have a MOSFET in series with it, such that the battery can be connected or disconnected from circuit according to the gate voltage applied to the MOSFET. The voltage to the gate may be generated by the controller which may use a number of inputs from different points in the circuit for its control inputs. It may have inputs from the battery, such that the instantaneous voltage on the battery can be sampled by the microprocessor. This feature is important for use when charging the battery module, with no load connected to the DC/DC output. The controller may also have an input from the AC/DC module, or from a point along its output, so that it can determine when the current dips are occurring, in order to time the MOSFET gate signal correctly. During these dips, the controller can measure the voltage on the battery by applying a control voltage to the gate of the MOSFET such that the battery is disconnected from the circuit whilst it is being measured by the controller. The current through the battery can also be measured by a current sensor. The controller may also provide a control input to the AC/DC converter, in order to control the output voltage of the converter in accordance with the parameters measured around the battery.

Besides the size and cost advantages of using a circuit topology with small capacitor smoothing, another feature of this charging system is that because of the comparatively poor level of smoothing used, the DC output voltage from the converter is allowed to fall below the level required to charge the internal battery or batteries of the system twice during each AC cycle, when the AC/DC converter thus stops providing output current to the internal battery. The output can even fall during these current dips, below the level required by the DC/DC converter to provide power to the portable device. During these periods of no charging current, one or more of the cells can be measured for such properties as battery chemistry, terminal voltage, temperature, charge fill, or any other property related to the cell or cells themselves. According to other configurations, the MOSFETs in series with the individual cells can be used for isolating the cells from the charging circuit and from the other cells in order to perform these measurements unimpeded, whether or not the charging current is paused because of the output dips. Furthermore, the MOSFETs can be used in a linear mode in order to control the current through any cell in accordance with the desired current flow, regardless of the battery voltage, such that weak or partially charged cells can be charged at their desired rate.

One exemplary implementation involves a charger, comprising:

(i) a first voltage converter, inputting AC power and outputting DC current at a first DC voltage, the first voltage converter having a smoothing characteristic such that there are periods during each cycle of the AC power during which the DC current falls substantially from its maximum value,
(ii) a second voltage converter, serially connected to the first voltage converter, and outputting power at a second DC voltage for powering an electronic device,
(iii) a cavity for accommodating a battery comprising at least one cell, the battery being connected at the output of the first voltage converter such that current can be received by the battery from the first voltage converter and supplied by the battery to the second voltage converter, and
(iv) a controller configured such that during at least part of the periods during which the DC current is substantial reduced from its maximum value, the controller regulates current flow from the battery to the second voltage converter, and during other parts of the cycle, the controller regulates current flow from the first voltage converter into the battery.

Such a charger may further comprise a smoothing capacitor associated with the first voltage converter, the capacitor having a value sufficiently low to generate the smoothing characteristic. In such a case, the smoothing capacitor is located on the output of the first voltage converter. Alternatively, the smoothing characteristic may arise from the absence of a smoothing capacitor, such that during parts of the periods during which the DC current is substantial reduced from its maximum value, the current flow from the battery is essentially the only current input to the second voltage converter for powering the electronic device.

In any of the above described chargers, in regulating the current flow to or from the battery, the controller may utilize at least one of:

(i) the verification of the presence of a battery,
(ii) the level of the first DC voltage,
(iii) the current flowing to or from the battery,
(iv) the terminal voltage of the battery, and
(v) the internal resistance of the battery.
If, according to option (i), the presence of an installed battery is not verified, the controller is configured to enable the first DC voltage to rise to a voltage higher than the rated voltage output that would be generated if a battery were installed.

Yet other implementations may involve a charger as described previously, wherein the controller regulates charge current flowing into the battery in accordance with the level of charge of the battery. In this exemplary case, the controller may regulate charge current flowing into the battery in accordance with a predetermined charge program adapted to charge the battery according to its status.

Furthermore, any of the above-described systems may further involve a charger wherein the controller regulates current drawn from the battery during the periods during which the DC current is substantial reduced from its maximum value, in accordance with the current requirements of the electronic device. Additionally, the controller may execute a predetermined routine for determining whether the battery is a primary or a secondary battery, in which case the controller should disable current flow to the battery if the battery is a primary battery.

Alternative implementations of any of the above-described systems may further involve a charger further comprising a gated switch in series with the battery, and wherein the controller regulates the current flow to or from the battery by means of the gated switch. The gated switch may advantageously be a Field Effect Transistor. The current flow to or from the battery may be regulated by operating the gated switch either in a timed switched mode, or in a linear mode.

In any of the above described chargers, the controller may be configured to prevent withdrawal of more energy from the battery than is input to the battery during any cycle.

Another example implementation can involve a charger, comprising:

(i) a first voltage converter, inputting AC power and outputting DC current at a first DC voltage, the first voltage converter having a smoothing characteristic such that there are periods during each cycle of the AC power during which the DC current falls substantially from its maximum value,
(ii) a second voltage converter, serially connected to the first voltage converter, and outputting power at a second DC voltage for powering an electronic device,
(iii) a cavity for accommodating a plurality of cells connected in parallel, the cells being connected at the output of the first voltage converter such that current can be received by the cells from the first voltage converter and supplied by the cells to the second voltage converter,
(iv) an electronic switch disposed serially to each of the cells, such that the electronic switch controls current flow to or from each of the cells, and
(v) a controller configured such that during at least part of the periods during which the DC current is substantial reduced from its maximum value, the controller regulates current flow from selected ones of the cells to the second voltage converter, and during other parts of the cycle, the controller regulates current flow from the first voltage converter into the selected ones of the cells.

Such a charger may further comprise a smoothing capacitor associated with the first voltage converter, the capacitor having a value sufficiently low to generate the smoothing characteristic. In such a case, the smoothing capacitor is located on the output of the first voltage converter. Alternatively, the smoothing characteristic may arise from the absence of a smoothing capacitor, such that during parts of the periods during which the DC current is substantial reduced from its maximum value, the current flow from the cells is essentially the only current input to the second voltage converter for powering the electronic device.

In any of the above described chargers incorporating parallel cells, in regulating the current flow to or from the cells, the controller may utilize at least one of:

(i) the verification of the presence of a cell,
(ii) the level of the first DC voltage,
(iii) the current flowing to or from the cell,
(iv) the terminal voltage of the cell, and
(v) the internal resistance of the cell.
If, according to option (i), the presence of any particular installed cell is not verified, the controller is configured to enable the first DC voltage to rise to a voltage higher than the rated voltage output that would be generated if a cell were installed.
Yet other implementations may involve a charger incorporating parallel cells as described previously, wherein the controller regulates charge current flowing into any one of the cells in accordance with the level of charge of the cell. In this exemplary case, the controller may regulate charge current flowing into the cell in accordance with a predetermined charge program adapted to charge the cell according to its status.

Furthermore, any of the above-described systems may further involve a charger incorporating parallel cells, wherein the controller regulates current drawn from the cells during the periods during which the DC current is substantial reduced from its maximum value, in accordance with the current requirements of the electronic device. Additionally, the controller may execute a predetermined routine for determining whether the cells are primary or secondary, in which case the controller should disable current flow to a cell if it is a primary cell.

The electronic switches described in these chargers may advantageously be Field Effect Transistors. The current flow to or from the cells may be regulated by operating these electronic switch either in a timed switched mode, or in a linear mode.

Yet other implementations may involve a charger, comprising:

(i) a first voltage converter, inputting AC power and outputting DC current at a first DC voltage, the first voltage converter having a smoothing characteristic such that there are periods during each cycle of the AC power during which the DC current falls substantially from its maximum value,
(ii) a second voltage converter, serially connected to the first voltage converter, and outputting power at a second DC voltage for powering an electronic device,
(iii) a cavity for accommodating a battery comprising at least one cell, the battery being connected at the output of the first voltage converter such that current can be received by the battery from the first voltage converter and supplied by the battery to the second voltage converter, and
(iv) a controller configured to regulate the flow of current into or out of the battery according to the state of charge of the battery.

Such a charger may further comprise a smoothing capacitor associated with the first voltage converter, the capacitor having a value sufficiently low to generate the smoothing characteristic. In such a case, the smoothing capacitor is located on the output of the first voltage converter. Alternatively, the smoothing characteristic may arise from the absence of a smoothing capacitor, such that during parts of the periods during which the DC current is substantial reduced from its maximum value, the current flow from the battery is essentially the only current input to the second voltage converter for powering the electronic device.

In any of such chargers, in regulating the current flow to or from the battery, the controller may utilize at least one of:

(i) the verification of the presence of a battery,
(ii) the level of the first DC voltage,
(iii) the current flowing to or from the battery,
(iv) the terminal voltage of the battery, and
(v) the internal resistance of the battery.
If, according to option (i), the presence of an installed battery is not verified, the controller is configured to enable the first DC voltage to rise to a voltage higher than the rated voltage output that would be generated if a battery were installed.

Yet other implementations may involve a charger as described immediately previously, wherein the controller regulates current drawn from the battery during periods during which the DC current is substantial reduced from its maximum value, in accordance with the current requirements of the electronic device. According to more implementations, such chargers may also execute a predetermined routine for determining whether the battery is a primary or a secondary battery, in which case the controller should disable current flow to the battery if it is a primary battery.

Alternative implementations of the immediately above-described systems may further involve a charger further comprising a gated switch in series with the battery, and wherein the controller regulates the current flow to or from the battery by means of the gated switch. The gated switch may advantageously be a Field Effect Transistor. The current flow to or from the battery may be regulated by operating the gated switch either in a timed switched mode, or in a linear mode.

In any of the immediately above-described chargers, the controller may be configured to prevent withdrawal of more energy from the battery than is input to the battery during any cycle.

Another exempalry implementation may involve a charger, comprising:

(i) a first voltage converter, inputting AC power and outputting DC current at a first DC voltage, the first voltage converter having a smoothing characteristic such that there are periods during each cycle of the AC power during which the DC current falls substantially from its maximum value,
(ii) a second voltage converter, serially connected to the first voltage converter, and outputting power at a second DC voltage for powering an electronic device,
(iii) a cavity for accommodating a plurality of cells connected in parallel, the cells being connected at the output of the first voltage converter such that current can be received by the cells from the first voltage converter and supplied by the cells to the second voltage converter,
(iv) an electronic switch disposed serially to each of the cells, such that the electronic switch controls current flow to or from each of the cells, and
(v) a controller configured to regulate the current flow into or out of the cells according to the state of charge of the cells.

Such a charger may further comprise a smoothing capacitor associated with the first voltage converter, the capacitor having a value sufficiently low to generate the smoothing characteristic. In such a case, the smoothing capacitor is located on the output of the first voltage converter. Alternatively, the smoothing characteristic may arise from the absence of a smoothing capacitor, such that during parts of the periods during which the DC current is substantial reduced from its maximum value, the current flow from the cells is essentially the only current input to the second voltage converter for powering the electronic device.

In any of the above described chargers incorporating parallel cells, in regulating the current flow to or from the cells, the controller may utilize at least one of:

(i) the verification of the presence of a cell,
(ii) the level of the first DC voltage,
(iii) the current flowing to or from the cell,
(iv) the terminal voltage of the cell, and
(v) the internal resistance of the cell.
If, according to option (i), the presence of any particular installed cell is not verified, the controller is configured to enable the first DC voltage to rise to a voltage higher than the rated voltage output that would be generated if a cell were installed.

In such chargers, the controller may regulate charge current flowing into any one of the cells in accordance with the level of charge of the cell. In this case, the controller may regulate charge current flowing into any one of the cells in accordance with a predetermined charge program adapted to charge the cells according to its status. Also, in such a charger, the controller may regulate current drawn from the cells during the periods during which the DC current is substantial reduced from its maximum value, in accordance with the current requirements of the electronic device. The charger may further incorporate a routine executed for determining whether the cells are primary or secondary, in which case the controller should disable current flow to cells if they are primary.

The electronic switches described in these chargers may advantageously be Field Effect Transistors. The current flow to or from the cells may be regulated by operating these electronic switch either in a timed switched mode, or in a linear mode.

The term “battery” should strictly be used in the art to mean a combination of a number of electrochemical cells. However, the term “battery”, in its popularly used sense, is often understood to be an electrochemical source, whether it consists of one or of several cells. It is to be understood that in this application, the term battery may have been used and may also have been claimed, in its popular meaning.

Furthermore, It is to be understood that this disclosure is applicable to power supplies regardless of how the battery is incorporated into the supply circuits. Since a battery cavity is the most common method of doing so, this term is used generically and is thuswise claimed, and is intended to include any manner of incorporation of a battery, whether a battery cavity or a battery holder, or a wired-in battery, or even an externally attached battery.

### BRIEF DESCRIPTION OF THE DRAWINGS

The presently claimed invention will be understood and appreciated more fully from the following detailed description, taken in conjunction with the drawings in which:

FIG. 1 illustrates schematically a circuit diagram of an exemplary wall charging unit described in this disclosure, for supplying DC current to a portable electronic device from an AC wall socket;

FIG. 2 illustrates the form of the current output from the AC/DC converter module when a charged battery is installed in the system;

FIG. 3 illustrates the form of the current output from the AC/DC converter module when no battery or a very weak battery is installed in the system;

FIG. 4 illustrates schematically the voltage-current output characteristics desired of the AC/DC converter used in the unit of FIG. 1; and

FIG. 5 illustrates schematically a circuit diagram of an exemplary wall charging unit, similar to that shown in FIG. 1, but whose battery is made up of a number of cells connected in parallel,

### DETAILED DESCRIPTION

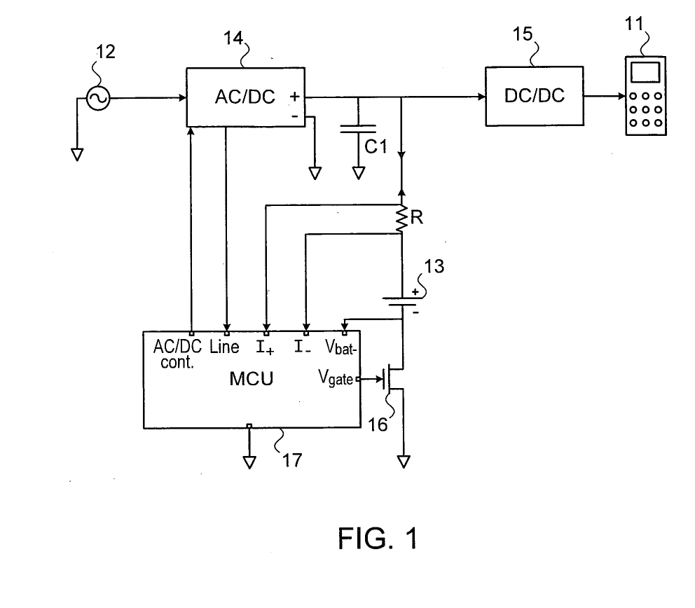

Reference is first made to FIG. 1, which illustrates schematically a circuit diagram of an exemplary wall charger power supply unit for supplying DC current to a portable electronic device 11 from an AC wall socket or other AC source 12. The wall charger incorporates one or more rechargeable cells 13 for powering the device 11 when no AC source is available, or when no AC source is connected. Certain aspects of the advantages of this type of circuit are also available when a primary cell is used in the device, instead of rechargeable cells. This situation is further discussed hereinbelow, but the main description is presented for situations using a rechargeable cell or cells.

The AC input to the power supply unit is converted, advantageously by an AC/DC switched mode power supply 14, which may be a pulse width modulation type, which outputs a roughly smoothed DC voltage of typically up to a few volts DC. This voltage is input to a second converter 15, this one being a DC/DC converter, which can convert a widely ranging DC input and provide a well smoothed DC output to supply the portable device 11. In addition, the output from the AC/DC converter is taken to the positive terminal of the battery module 13. This double stage power supply is similar to that described in the above mentioned co-pending published International Application WO2009/113062. In this exemplary circuit, no smoothing capacitor is used at the output of the rectifier bridge inputting the AC power to the converter, and a comparatively small capacitor C1 may be used at the output of the AC/DC converter, as described in that application, thus reducing the size and cost of the charger. In general, one possible criterion for selecting the value of the capacitor to provide the advantages of this topology would be to ensure that a major part of the capacitor's stored energy is discharged during each half cycle of the AC. Use of an output capacitor C1 having such a small value, means that the output ripple of the AC/DC converter may be comparatively high, such that the output voltage may dip significantly as the line voltage falls, twice every cycle, below the level that provides the rated output voltage. However, as will be explained hereinbelow, this fall in output does not significantly affect the two main functions of the circuit, namely (i) charging any built-in battery or batteries 13, and (ii) providing output power to the portable device 11 through the DC/DC converter 15. Furthermore it is the dip in output caused by this poor smoothing that enables the achievement of a number of the novel features of the present charging system. Therefore the comparatively poor smoothing, which may be produced by the use of an output capacitor having a capacitance substantially lower than that generally usually used in prior art power supplies, may be considered to be one of the important features of the present described power supply systems.

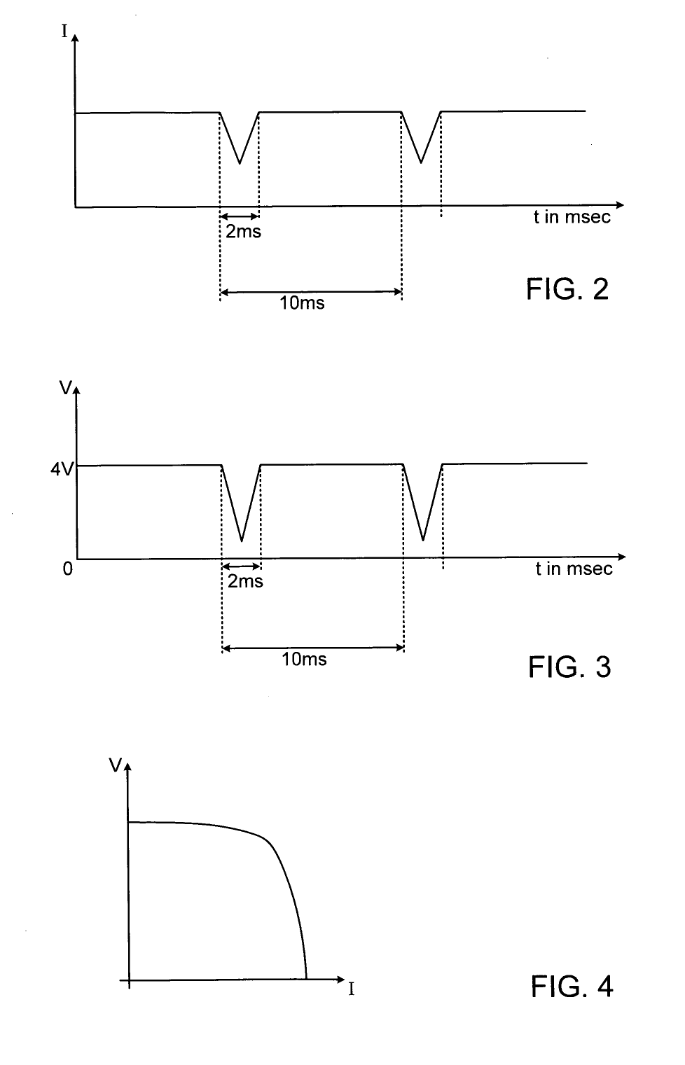

In order to follow the operation of the system, reference is made to FIG. 2 which illustrates the form of the current output from the AC/DC converter module. For a 50 Hz mains input, which translates into a 100 Hz current cycle when the preferred full wave rectification is used, the output voltage is constant at its rated level, except for dips at 10 millisecond intervals, when the input voltage from the rectifier bridge falls below the level required to maintain the plateau voltage of the output capacitor, as explained above and in the above-mentioned WO2009/113062. The width of these dips may be typically of the order of 2 msec. out of the 10 msec. repetition time, depending on the AC/DC converter regulation properties, and on the load current drawn. For most of the cycle time the AC/DC converter is therefore supplying current for charging the battery module 13, or for outputting through the output DC/DC converter. The voltage on the positive terminal of the battery module, on the other hand, is approximately constant at the output voltage of the battery module 13.

The positive output of the battery module is directed to the DC/DC converter 15 whose output is a stabilized DC voltage for operating the mobile device 11 to which the charger is connected. This output may have the well-known voltage/current source characteristic, providing a fairly constant voltage up to the maximum current which can be supplied, beyond which the voltage falls rapidly to zero.

So long as the output of the AC/DC module is at its normal operating level, it supplies current to the load via the DC/DC converter module 15. When, because of the cyclic falls in the AC input voltage, the output drops below the terminal voltage of the battery module 13, the current shortfall to the load may be made up from the battery module 13. The AC/DC module 14 charges the battery module during that part of the cycle in which it outputs its rated voltage level. During the voltage dips, when the AC/DC module can no longer provide current for the device load 11, the battery 13 supplies the current for the load 11. Since the current supply time is significantly longer than the length of the current dips, there may also be an overall charging effect on the cells, if they need to be charged. One of the advantages of this scheme is that there is no need for a large smoothing capacitor at the input of the AC/DC module, since the resulting dips in the supplied current do not interfere with the operation of the charger. During the voltage dips, the system continues to supply current from the batteries, and even if no battery were installed, the depth of the dips, within reasonable limits, does not affect operation of the load because of the buffering effect of the DC/DC converter. Furthermore, it is known that periodic discharge of the battery is advantageous to battery life and charge capacity, such that the drawing of current from the battery module during the AC/DC converter dips also has a positive effect on the battery itself.

Proper operation of the power supply is ensured by means of a controller, such as a microprocessor or microcontroller 17 which manages the current flow within the power supply. The microprocessor ensures that the DC/DC converter receives the energy needed to power the device, whether from the battery module 13 or from the AC/DC converter 14, and that the AC/DC converter provides sufficient charging power to the battery only when battery charging is possible. The battery module 13 may have a gated switch, such as a MOSFET 16 in series with it such that the battery can be connected or disconnected from circuit according to the gate voltage applied to the MOSFET. The voltage to the gate, V_{gate}, may be generated by the microprocessor 17 which may use a number of inputs from different points in the circuit for its control inputs. It may have inputs from the battery, V_{bat-} and I₋ at which V_{bat+} is measured, such that the instantaneous voltage on the battery can be sampled by the microprocessor. This feature is important for use when charging the battery module, with no load connected to the DC/DC output. The microprocessor also may have an input from the AC/DC module, marked “Line” in FIG. 1, or from its output, so that it can determine when the current dips are occurring, in order to time the MOSFET gate signal correctly. During these dips, the microprocessor can measure the voltage on the battery by applying a control voltage V_{gate}, to the gate of the MOSFET such that the battery is disconnected from the circuit whilst it is being measured by the microprocessor. The current through the battery can also be measured by measuring the voltage across a small current sensing resistor R, and inputting to the microprocessor at pins I₊, I₋. The MOSFET can be located either on the negative side of the battery or on the positive side of the battery, between the battery and the current input from the AC/DC converter. The microprocessor may also provide a control input, AC/DC_{cont} to the AC/DC converter, in order to control the output voltage of the converter in accordance with the parameters measured around the battery.

When no batteries are installed, the system must continue to operate in the normal way, supplying current from the AC mains 12, to the load 11. As previously mentioned, when a battery is present, the voltage on the capacitor C1 and at the output of the AC/DC module is fixed at the battery voltage. In the absence of a battery, or when a depleted battery is present, the voltage on the capacitor is allowed to rise, to a level determined either by the output characteristics of the AC/DC converter module or by the control signal received by the AC/DC module from the microprocessor 17, or by a combination of both. The AC/DC characteristics are predetermined in order to allow the capacitor voltage to rise to a level several times that of the battery voltage. A typical value could be of the order of 8 to 12 V for a system outputting 5V at the DC/DC output. This comparatively higher voltage generated on the capacitor is important, since it enables the capacitor to store considerably more energy than it would generally need to store when a battery is installed. Without an installed battery, it is this capacitor energy which is used to supply the load with its current during the current dips. A capacitor with a value considerably smaller than that used in conventional power supplies can be used, since the output voltage at this point is allowed to fall considerably, there being another stage of conversion by the DC/DC converter 15 before the current is applied to the load, such that these dips are of limited consequence.

Referring now to FIG. 3, it is seen that the capacitor voltage behavior is similar to the current supply output behavior of the AC/DC module, falling at the dips in the AC cycle, when the AC input voltage can no longer supply the desired output voltage. The fall can even be allowed to be substantial, for instance down to half, or even less of the stable maximum, with the missing corresponding output current being supplied to the load from the energy stored in the capacitor.

There are five main different modes of operation of the charging system:

(i) When the battery is fully or almost fully charged, and is in good condition, the current from the AC/DC converter is used primarily for powering the device 11 directly through the DC/DC converter, and a part of the current is directed to charge the battery 13 to maintain it in a fully charged state. Under these conditions the capacitor voltage is kept close to the battery terminal voltage, such that it does not store a large reserve of energy. When the current from the AC/DC converter dips at each half cycle, below the level required by the load, the load is supplied primarily with current from the battery 13, with the small level of discharge of the battery's charge being replenished by the AC/DC converter during the successive current flow. The battery thus acts like a storage capacity, providing pulses of energy only during the AC/DC output voltage dips. Discharge of the energy stored in the capacitor C itself is comparatively unimportant for this mode of operation. If the battery is in good condition but is only in a partially charged state, then during the current flow periods, the output current of the AC/DC converter, should be higher and divided differently, with more of the output current being diverted to charge the battery than in the fully charged case.
(ii) When no battery is installed in the system, the output of the AC/DC converter is allowed to rise to a higher level than that obtained when a battery is installed. This situation can be detected by the microprocessor, either because of the characteristics of the AC/DC converter or because the lack of current flow into the battery is used to input a signal to the AC/DC module to allow its output voltage to rise, such as to 4V, as shown in the example of FIG. 3. Considerably more energy is thus stored on the capacitor, since the energy stored in a capacitor is proportional to the square of the voltage thereon. In this situation, the load current during the periodic dips in the AC/DC converter output is provided exclusively by discharge of the energy in the capacitor C, which, because of its higher stored energy, can provide this energy shortfall to the device.
(iii) When the battery is weak or is in a poor state of charge, as determined by measurements performed during the dips in the AC/DC converter output, and which are then input to the microprocessor, special charging procedures should be used to ensure optimum charging of the battery. Firstly, the battery should be charged more slowly than a strong or fully charged battery, and generally at a smaller current than required to supply to the load. Such a procedure has been described as the precharging procedure in co-pending PCT Patent Application PCT/IL2007/001532 for “Charging Methods for Battery Powered Devices”, published as WO2008/072232, herewith incorporated by reference in its entirety. Secondly, in order to preserve its accumulated charge, the battery should not be allowed to discharge to the DC/DC converter for output to the load device. The load device should therefore receive its input power during the AC/DC output power dips, exclusively from the capacitor. Accordingly, for this situation, the microcontroller 17 should enable the AC/DC output voltage to rise, such that more energy is stored on the capacitor to provide the load with its required current during the AC/DC output dips. In addition, the battery should be charged more slowly during the output voltage plateau periods, as mandated for a weak or partly charged battery. The charging current may be controlled by using the serial MOSFET 16 in a linear mode rather than as an ON-OFF switch, such that it behaves as a linear current source, controlling the charging current continuously in accordance with the control input signals provided by the microprocessor 17. This is described more fully hereinbelow. The microprocessor can sense the battery charging current either using the voltage developed across the sensing resistor R, or by testing the rise in battery voltage with charge time, which essentially measures the internal resistance of the battery, as described in the above-mentioned WO2008/072232.
(iv) If a primary battery is installed in the charging system, this can be detected by a battery chemistry detection system actuated when the battery is disconnected from circuit by the MOSFET 13. The above-referenced WO2008/072232 contains descriptions of such battery chemistry detection procedures. Such a primary battery can still supply current to the load during the AC/DC output dips, although the MOSFET 16 should be kept in an open state during the periods when the AC/DC output is high, to prevent charging current from being directed into the primary battery. Alternatively, the controller may be programmed such that when a primary battery is detected, it is connected into circuit by its MOSFET and allowed to discharge, only in conditions where the power supply is detached from the AC power source, such that the internal battery becomes the only source of power. By this means, charging of the primary battery is disenabled.
(v) When the power supply is not connected to an AC power source, then the battery module 13, provides current directly to the DC/DC converter 15 for supplying to the load device 11.

As previously mentioned the AC/DC converter 14 can also be designed to provide an output suited to the working conditions required, without necessarily requiring a control input from the microprocessor 17. Reference is now made to FIG. 4, which illustrates schematically the voltage-current output characteristics desired of the AC/DC converter, which enable the converter to adapt itself to the conditions required by the charging system. As is observed, this converter behaves as a current/voltage source. So long as sufficient current is being drawn, the converter behaves close to a pure current source, with the voltage falling to adapt itself to the current drawn. If, on the other hand, the current drawn from the AC/DC converter falls below a predetermined value, such as will be the case when no battery requiring charging is present, the output voltage will rise until the AC/DC converter behaves as essentially a pure voltage source, as shown in FIG. 4. This is a situation which exists in cases (ii) to (iv) above, and for the example used herewithin of a 1.5 volt cell, the output voltage may be allowed to rise to the order of about 4 V, which is the open circuit output of the AC/DC converter of this example.

In addition to the control resulting from the AC/DC converter characteristics, the current flowing from the converter can also be continuously controlled by means of the serial MOSFET 16, as mentioned above in case (iii). Thus even when the AC/DC converter is outputting a low or moderate current at its full 4V output voltage, by controlling the MOSFET linearly, it is possible to control the average current drawn from the AC/DC module. Although in order to control the current, it is generally preferable to utilize the AC/DC converter characteristics rather than the linear mode of the MOSFET, since FET switching involves wasted power, heating, and less efficiency, FET switching can be used in situations where the battery current needs to be controlled at points not accessible by the AC/DC converter characteristics. For instance, as in case (iii) above, if a weak or a comparatively low charged battery is in circuit, and there is need to control the battery input current, for instance, to test the battery chemistry, or to check the internal resistance of the battery by measuring the current change through it as a function of a voltage increment across it, or to perform a pre-charging process in order to increase its charge content, and the output voltage of the AC/DC converter is at its maximum level of 4 V, then the series FET may be used in its linear mode in order to control this current to perform the required functions.

A more efficient mode of operation is to use the MOSFET in a time switched mode, allowing flow of current into the battery only in accordance with the state of the battery or the state of charge of the battery. This control ensures that the average current applied to the battery does not exceed the average charging current suitable for that type of battery.

Alternatively, it is possible to directly control the output current of the AC/DC converter, using a control input to the AC/DC converter derived from the microprocessor, based on the circuit parameters which the microprocessor measures. This then entirely obviates the need for the MOSFET. The output current can either be controlled directly, or the output voltage of the AC/DC converter can be controlled such that the desired output current is obtained through the current/voltage characteristic of the system.

A further example by which the microprocessor 17 can be used to control the operation of the system, is provided by use of a dynamic algorithm to determine how to drive the AC/DC converter as a function of current and voltage measurements, and the current demanded by the load. This method can be used instead of the use of the characteristics measured during the voltage dips or using the MOSFET switching function. This algorithm essentially determines the state of the battery, and the load requirement, and hence how to drive the AC/DC converter. Using the current sensing resistor R, the current flowing into or out of the battery is known and its value input to the microprocessor 17, and the battery terminal voltage is also measured and input to the microprocessor 17. The coincidence of a high battery current discharge coupled with a low terminal voltage indicates that the battery is in a depleted state, and the algorithm then provides the appropriate output command to the AC/DC converter to operate in a dominantly battery charging mode. Conversely, the coincidence of a low battery discharge current coupled with a high terminal voltage indicates that the battery is in a fully charged state, and the algorithm then provides the appropriate output command to the AC/DC converter to operate in a dominantly load directed current mode. This algorithm is operable at any point of time in the AC cycle.

The above implementations have been described in terms of a wall charger incorporating a single battery, without any reference to the number of cells in the battery. The battery has been viewed as a two terminal device, generating an EMF, without regard to its content. However it is also possible to use a plurality of individual cells in the charger, and to control the charge current running into each of the cells separately, or the load current drawn from each of them separately. Such an implementation has advantages, providing the ability to charge each individual cell according to, inter alia, its type, its current state of charge, and its overall capacity.

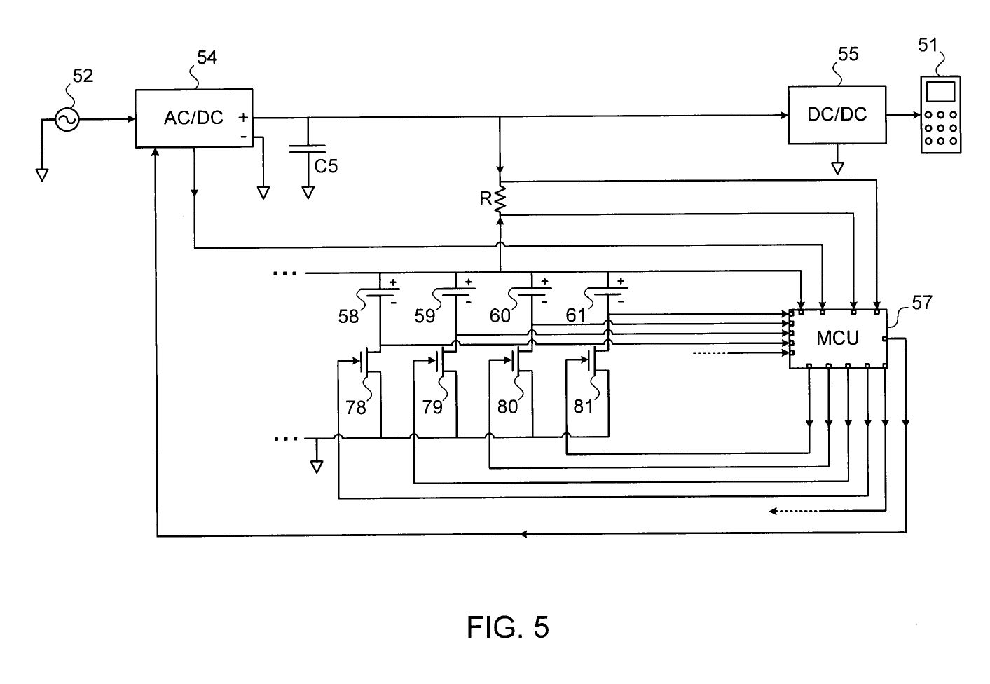

Reference is now made to FIG. 5, which illustrates schematically a circuit diagram of such an exemplary wall charging unit, incorporating a number of rechargeable cells connected in parallel, such as could be used for powering the device when no AC source is available or when no AC source is connected. A central feature of this example is the plurality of battery cells connected in parallel, each cell having a MOSFET in series with it such that each can be connected or disconnected from the system according to the gate voltage applied to the MOSFET. The voltage to each gate is generated by a microprocessor which uses as control inputs, a number of measured values relating to the performance of each cell and the requirements demanded of each cell. Each of the cells in the battery unit can thus be individually charged according to its needs and what is required of it.

In common with the exemplary single battery system described above, in the present system, the AC input 52 to the charging unit is expediently converted by an AC/DC switched mode power supply 54, generally of the pulse width modulation type, which outputs a roughly smoothed DC voltage of up to a few volts DC. This voltage is input to a second converter 55, a DC/DC converter, from which a low ripple DC output is taken to supply the portable device 51. A comparatively small capacitor C5 may be used at the output of the AC/DC converter.

The output from the AC/DC converter 54 is taken to the positive bus of the multi-cell battery module. This module contains a number of separate cells, 58, 59, 60, 61, . . . each connected between the positive bus and the system ground. A MOSFET 68, 69, 70, 71, . . . is connected in series with each of the cells, either between the cell and the system ground or between the cell and the positive bus. Each cell can thus be connected or disconnected from circuit according to the gate voltage applied to the MOSFET. As is apparent from the previously described FIGS. 2 and 3, for most of the AC cycle, the AC/DC module supplies current to the positive bus of the multi-cell battery module. The voltage on the positive bus is approximately constant at the level supplied by the multi-cell battery module, typically 1.5 V.

The positive bus of the multi-cell battery module is output to the DC/DC converter 55 whose output is a well smoothed DC voltage for operating the mobile device to which the charger is connected.

So long as the output of the AC/DC module 54 is at its plateau level, it supplies current to the load 51 via the DC/DC converter module 55, and when the output drops because of the cyclic falls in the AC input voltage, the current shortfall to the load is made up from the multi-cell battery module. If any of the cells are more discharged than the others and require topping up, then the same logic applies with regard to the charging current from the AC/DC converter 54 to the cells 58, 59, . . . . The AC/DC module charges the cells so long as it outputs its rated current level, and at the current dips, the cells discharge in order to supply the load. Since the current supply time at the plateau voltage is significantly longer than the width of the current dips, there is an overall charging effect on the cells. One of the advantages of this scheme is that there is no need for a good level of smoothing, such as by means of a large capacitor at the input of the AC/DC module, since the dips in the supplied current do not interfere with the operation of the charger. During the current dips, the system continues to supply current from the batteries, and the depth of the dips, within reasonable limits, does not affect operation of the load.

Each cell generally has a MOSFET in series with it such that cell can be connected or disconnected from circuit according to the gate voltage applied to the MOSFET. The voltage to the gate is generated by a microprocessor or microcontroller 57 which uses a number of inputs from different points in the circuit for its control inputs. It has inputs from the cells themselves, such that the instantaneous voltage on each cell can be sampled by the microprocessor 57. A current sense input obtained from a sense resistor R can also be provided to determine the instantaneous current flowing through each cell. This sensing function can either be a single resistor in the lead from the output bus of the AC/DC converter to the multi-cell battery module, as shown in FIG. 5, in which case the current readout will be dependent on which MOSFET is enabling connection of which cell to the bus, or a sense resistor can be provided in series with each cell, such that the instantaneous current flowing through each cell can be determined continuously. The microprocessor may also have an input from the AC/DC module, so that it can determine when the current dips are occurring, in order to time the MOSFET gate signal correctly. During these dips, the microprocessor can measure the voltage on each cell by applying a control voltage to the gate of the MOSFET such that the relevant cell is disconnected from the circuit whilst it is being measured by the microprocessor. The microprocessor 57 may also have an output to the AC/DC converter, in order to control the output voltage of the converter in accordance with the parameters measured relating to each cell.

Use of the individual cells connected in parallel may be the most efficient way of using the cells, since a single weak cell will not limit the discharge capabilities of the entire battery module. Furthermore such a single weak cell may be charged appropriately, using a lower charge current and a precharge procedure, by correct switching of the appropriate MOSFETs. Thus, for instance, if a battery has some strong cells and some weak cells in parallel, the switches and power supply control can be programmed such that the strong cells are charged at their full rate, and operate as capacitors, providing power to the load while the AC/DC output is low, in accordance with the AC/DC converter control. The weak cells, on the other hand, may be treated appropriately as described above, being charged at a lower charge current, and being disconnected from the load during the AC/DC current dips, while the capacitor is allowed to develop a higher voltage to continue supplying the load during the AC/DC output dips. The control of the current into the weak cells can then be achieved using the linear control mode of its serial MOSFET. Thus, it is possible to independently control the appropriate current behavior for each cell of the battery by sequential measurement and control in successive cycles of the AC input. During each cycle, or more accurately, during each half cycle, a different cell is measured during the current dip, in order to determine its state, and hence, how to charge it or utilize its charge during the coming half-cycle. As an alternative to sequential measurement and charging, it is possible to perform this procedure to several or all of the cells simultaneously.

It is also possible to connect the cells in the battery module in other ways such as series or series parallel combinations. For each particular combination, the microprocessor should program the switching of the MOSFETs so that each of the cells is correctly charged, at the rate and to the voltage required.

Furthermore the multi-cell parallel battery pack allows the use of mixed cells in the battery module, and when battery chemistry detection is fitted to the system, each cell will be charged or not according to its type. In this respect, the use of the linear mode MOSFET enables the battery chemistry determination to be readily performed, since it enables, independently of the cell voltage itself, close control of the current through the cell, such as is required for the precharge procedure for battery chemistry detection, where a current of only 100 or 200 mA is required for the test, The power supplies described in this application are thus sufficiently flexible that they are able to handle different combinations of cells within a battery, each cell being charged or discharged in accordance with its particular type and condition, and the environmental conditions around it, and the load to which the battery is attached, with the decisions regarding each cell being made by the controller in real time and at each successive cycle of the AC input power.

It is appreciated by persons skilled in the art that the present invention is not limited by has been particularly shown and described hereinabove. Rather the scope of the present invention includes both combinations and subcombinations of various features described hereinabove as well as variations and modifications thereto which would occur to a person of skill in the art upon reading the above description and which are not in the prior art.

1. A wall charger, comprising:
a first voltage converter, receiving input AC power and outputting DC current at a first DC voltage, said first voltage converter having a smoothing characteristic such that there are periods during cycles of said AC power during which said DC current falls from its maximum value;
a second voltage converter, serially connected to said first voltage converter, and outputting power at a second DC voltage for powering an electronic device containing an internal battery;
a cavity for accommodating a charger battery comprising at least one cell, said charger battery being connected at output of said first voltage converter such that current can be received by said charger battery from said first voltage converter and supplied by said charger battery to said second voltage converter; and
a controller configured such that during at least part of said periods during which said DC current is reduced from its maximum value, said controller regulates current flow from said charger battery to said second voltage converter, and during other parts of said cycle, said controller regulates current flow from said first voltage converter into said charger battery.

2. A wall charger according to claim 1, further comprising a smoothing capacitor associated with said first voltage converter, and wherein said capacitor has a value sufficiently low to generate a smoothing characteristic such that said DC current falls substantially from its maximum value during said periods during cycles of said AC power.

3. (canceled)

4. A wall charger according to claim 52, wherein during those parts of said periods during which said DC current is reduced from its maximum value, said current flow from said charger battery is essentially the only current input to said second voltage converter for powering said electronic device and its internal battery.

5. A wall charger according to claim 1, wherein in regulating said current flow to or from said charger battery, said controller utilizes at least one of:
verification of presence of a charger battery;
level of said first DC voltage;
level of charge of said charger battery;
terminal voltage of said charger battery; and
internal resistance of said charger battery.

6. (canceled)

7. A wall charger according to claim 5, wherein said controller regulates charge current flowing into said charger battery in accordance with a predetermined charge program adapted to charge said charger battery according to its status.

8. A wall charger according to claim 1, wherein said controller regulates current drawn from said charger battery during said periods during which said DC current is reduced from its maximum value, in accordance with current requirements of said electronic device and its internal battery.

9. A wall charger according to claim 1, wherein said controller is adapted to execute a predetermined routine for determining whether said charger battery is a primary or a secondary battery, and wherein said controller disables current flow to said charger battery if said charger battery is a primary battery.

10. A wall charger according to claim 1, further comprising a gated switch in series with said charger battery, and wherein said controller regulates said current flow to or from said charger battery by means of said gated switch.

11. (canceled)

12. A wall charger according to claim 10, wherein said current flow to or from said charger battery is regulated by operating said gated switch in either of a timed switched mode or a linear mode.

13. (canceled)

14. A wall charger according to claim 2, wherein if either one of no installed battery or a primary installed battery is detected in said cavity, said controller is configured to enable said first DC voltage to rise to a voltage higher than a rated voltage output that would be generated if a rechargeable battery were installed in said cavity.

15-27. (canceled)

28. A wall charger, comprising:
a first voltage converter, receiving input AC power and outputting DC current at a first DC voltage, said first voltage converter having a smoothing characteristic such that there are periods during cycles of said AC power during which said DC current falls from its maximum value;
a second voltage converter, serially connected to said first voltage converter, and outputting power at a second DC voltage for powering an electronic device containing an internal battery;
a cavity for accommodating a charger battery comprising at least one cell, said charger battery being connected at output of said first voltage converter such that current can be received by said charger battery from said first voltage converter and supplied by said charger battery to said second voltage converter; and
a controller configured to regulate the flow of current into or out of said charger battery according to at least one of the state of charge and the chemistry of said charger battery.

29. A wall charger according to claim 28, further comprising a smoothing capacitor associated with said first voltage converter, and wherein said capacitor has a value sufficiently low to generate a smoothing characteristic which results in said DC current falling substantially from its maximum value during said periods of cycles of said AC power.

30. (canceled)

31. A wall charger according to claim 28, wherein said smoothing characteristic arises from the absence of a smoothing capacitor, such that during parts of said periods during which said DC current is reduced from its maximum value, said current flow from said battery is essentially the only current input to said second voltage converter for powering said electronic device and its internal battery.

32. A wall charger according to claim 28, wherein said controller utilizes at least one of:
verification of the presence of a charger battery;
said first DC voltage at output of said first voltage converter;
level of charge of said charger battery;
terminal voltage of said charger battery; and
internal resistance of said charger battery,
in order to regulate said flow of current into or out of said charger battery.

33. A wall charger according to claim 28, wherein said controller regulates current drawn from said charger battery during periods during which said DC current is substantially reduced from its maximum value, in accordance with current requirements of said electronic device and its internal battery.

34. (canceled)

35. A wall charger according to claim 28, further comprising a gated switch in series with said charger battery, and wherein said controller regulates said current flow to or from said charger battery by means of said gated switch.

36. (canceled)

37. A wall charger according to claim 35, wherein said current flow to or from said charger battery is regulated by operating said gated switch in either of a timed switched mode and a linear mode.

38-51. (canceled)

52. A wall charger according to claim 1, wherein said smoothing characteristic arises from absence of a smoothing capacitor associated with said first voltage converter, such that said DC current falls substantially from its maximum value during said periods during cycles of said AC power.

53. A wall charger according to claim 1, wherein manner of incorporation of said charger battery can be any one of in a battery cavity or a battery holder, or as a wired-in battery, or as an externally attached battery.

54. A wall charger according to claim 1, wherein said controller is further configured to regulate flow of current into or out of said charger battery according to at least one of state of charge and chemistry of said charger battery.

55. A wall charger according to claim 1, wherein said charger battery comprises a plurality of cells connected in parallel, said wall charger further comprising:
an electronic switch disposed serially to each of said cells, such that said electronic switch controls current flow to or from each of said cells, and;
wherein said controller is configured such that during at least part of said periods during which said DC current is reduced from its maximum value, said controller regulates current flow from selected ones of said plurality of cells to said second voltage converter, and during other parts of said cycle, said controller regulates current flow from said first voltage converter into said selected ones of said plurality of cells.

56. A wall charger according to claim 55, wherein said controller is further configured to regulate said current flow into or out of selected ones of said cells according to at least one of state of charge and chemistry of said selected ones of said cells.
